(19) United States
(12) Patent Application Publication
(10) Pub. No.: US 2011/0231726 A1
(43) Pub. Date: Sep. 22, 2011

(54) REPEATER AND METHOD

(75) Inventor: Tomonori YAZAKI, Saitama (JP)

(73) Assignee: KDDI CORPORATION, Tokyo (JP)

(21) Appl. No.: 13/038,791

(22) Filed: Mar. 2, 2011

(30) Foreign Application Priority Data
Mar. 19, 2010 (JP) 2010-64212

(51) Int. Cl. G06F 11/14

(52) U.S. Cl. 714/749; 714/E11.141

(57) ABSTRACT

A repeater relays a PING signal of a USB 2.0 with low communication load and a few delays.

A host side repeater (20) transfers the PING signal from a host (10) to a device (12) and transmits a NAK signal to the host (10). The host side repeater (20) transmits the NAK signal to the host (10) against the PING signal from the host (10) before receiving the response from the device (12). The host side repeater (20) transmits an ACK signal to the host (10) if the response from the device (10) is the ACK signal, and transfers the PING signal to the device (12) and transmits the NAK signal to the host (10) if the response from the device (12) is not the ACK signal against the PING signal from the host (10) immediately after having received the response from the device (12).

### PRIORITY CLAIM

This application claims priority from Japanese patent application No. 2010-064212, filed on Mar. 19, 2010, which is incorporated herein by reference.

### BACKGROUND OF THE INVENTION

1. Field of the Invention

The present invention relates to a repeater and method relaying communication in a communication system that a host controls a transmission of a device and limits the transmission of the device for a predetermined period after the device received a signal from the host, such as a universal serial bus (USB).

2. Description of the Related Art

In the case the USB interface is relayed with the communication media which is different from the USB, such as a wired LAN, a wireless LAN, and an infrared light, it is necessary to overcome a restriction of a response time TAT (turn around time) defined by the USB communication.

U.S. Pat. No. 6,603,744, US Patent publication No. 2005/0080935, and Japanese patent publications No. H11-112524, No. 2000-284872, No. 2006-243866, No. 2005-129008, and No. 2005-129010 describe a proxy response method that the repeater arranged between the USB host and the USB device transmits a response packet to the USB host instead of the USB device.

### BRIEF SUMMARY OF THE INVENTION

Since a PING packet is newly introduced in USB 2.0, it is necessary for the repeater to accept this PING packet, and further to relay the data communications with a few delays. In general, it is requested for not only the USB but also the communication system that a host controls a transmission of a device and limits the transmission of the device for a predetermined period after the device received a signal from the host.

Therefore, it is an object of a present invention to provide the repeater and method which the request is satisfied.

A repeater of the present is a repeater relaying communication in a communication system that a host controls a transmission of a device and limits the transmission of the device for a predetermined period after the device received a signal from the host, the repeater comprising: a down buffer for temporarily storing a down signal from said host to said device; a up buffer for temporarily storing a up signal from said device to said host; a response signal generation means for generating a predetermined response signal that should be transmitted to said host; and a control means for controlling said down buffer, said up buffer and said response packet generation means according to said up signal and said down signal, wherein the control means (1) transfers an inquiry signal from said host to the device to said device via said down buffer, and has a NAK signal generate with said response packet generation means and transmits to said host, (2) has the NAK signal generate with said response packet generation means and transmits to said host against the inquiry signal from said host before receiving the response from said device, (3) transmits an ACK signal to said host if the response from said device is the ACK signal, and transfers said inquiry signal to said device via said down buffer, has the NAK signal generate with said response packet generation means, and transmits to said host if the response from said device is not the ACK signal against the inquiry signal from said host immediately after having received the response from said device.

A method of the present is method relaying an inquiry signal from a host to device in a communication system that the host controls a transmission of the device and limits the transmission of the device for a predetermined period after the device received a signal from the host, the method comprising steps of: transferring the inquiry signal from said host to said device, and transmitting a NAK signal to said host, transmitting the NAK signal to said host against the inquiry signal from said host before receiving the response from said device, and transmitting an ACK signal to said host if the response from said device is the ACK signal, and transferring said inquiry signal to the device and transmitting the NAK signal to said host if the response from said device is not the ACK signal against the inquiry signal from said host immediately after having received the response from said device.

According to the present invention, since the repeater reduces the relay of the inquiry signal, a communication load for reply is reduced.

### BRIEF DESCRIPTION OF THE SEVERAL VIEWS OF THE DRAWINGS

FIG. 1 shows an outline constitution block diagram of one embodiment of the present invention;

FIG. 2 shows a main flow of a CPU 26 of a host side repeater 20;

FIG. 3 shows a flow chart of an OUT transaction relay process;

FIG. 4 shows a detailed flow chart of a response wait process of the FIG. 3;

FIG. 5 shows a detailed flow chart of an ACK response wait process of the FIG. 4;

FIG. 6 shows a sequence example of an OUT transaction in the present embodiment when a device 12 replies an ACK packet against a DATA packet;

FIG. 7 shows a sequence example of an OUT transaction in the present embodiment when the device 12 replies a NAK packet against a DATA packet;

FIG. 8 shows a sequence example of an OUT transaction in the present embodiment when the device 12 replies a NYET packet against a DATA packet;

FIG. 9 shows a sequence example of an out transaction in the present embodiment when the device 12 replies a STALL packet against a DATA packet; and

FIG. 10 shows a flow chart of an IN transaction relay process.

### DETAILED DESCRIPTION OF THE INVENTION

An embodiment of the present invention will be described below with reference to the drawings in detail.

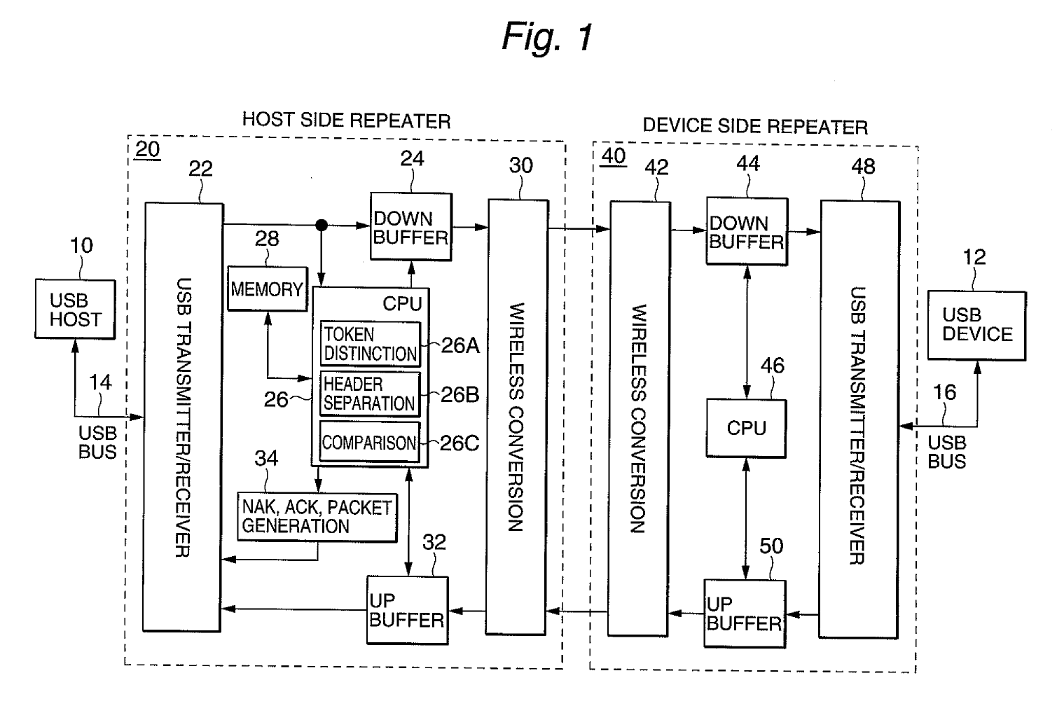

FIG. 1 shows an outline constitution block diagram of one embodiment of the present invention. A host side repeater 20 and a device side repeater 40 are arranged between a USB host (as below, it is abbreviated to “host”) 10 and a USB device (as below, it is abbreviated to “device”) 12. The host 10 is connected to the host side repeater 20 via a USB bus 14 (or a USB cable 14). The device 12 is connected to the device side repeater 40 via a USB bus 16 (or a USB cable 16). The host side repeater 20 and the device side repeater 40 are communicated each other by a known infrared light communication method. Instead of the infrared light communication, it may use a wired LAN or a wireless LAN. Note that in this embodiment, the signal flow to the device 12 from the host 10 is represented down and the signal flow to the host 10 from the device 12 is represented up.

The basic signal flow of the present embodiment will be described by the example of an OUT transaction case of the present embodiment. In the OUT transaction, the host 10 outputs an OUT packet, a DATA 0/1 packet and a PING packet to the device 12. The OUT packet is the packet that announces a start of the OUT transaction. The DATA 0/1 packet is the packet that carries data. The PING packet is the packet that inquires of the operating conditions of the device and also permits the response to the device 10. On the other hand, the packet that the device 10 transmits to the host 10 in the OUT transaction is any of an ACK packet, a NAK packet, a NYET packet, or a STALL packet. The ACK packet indicates the receiving of the packet. The NAK packet indicates the failure of the receiving of the packet. The NYET packet indicates unfinished preparations for data receiving for example the state that a buffer for receiving has no free space. The STALL packet indicates the trouble to obstruct communication, for example the device transmits the STALL packet to the host when the device cannot understand the device request from the host. When the host receives the STALL packet from the device, thereafter, the host quits the communication to the device.

The packet that the host 10 transmits to the USB bus 14 inputs the host side repeater 20. A USB transmitter/receiver 22 of the host side repeater 20 receives a packet from the USB bus 14 and supplies to a down buffer 24 and a CPU 26. The down buffer 24 takes the packet from the USB transmitter/receiver 22, and outputs to a wireless conversion device 30 or breaks under the control of the CPU 26. In OUT transaction, the broken packets are the PING packet which is an unnecessary packet to transfer to the device 12 and the DATA 0/1 packet which overlaps for the device 12 and the CPU 26 erases these packets from the down buffer 24. If the down buffer 24 is a ring buffer, an unnecessary buffer can be erased from the down buffer 24 by correcting a read address point.

As functions implemented by a operating program, the CPU 26 has a token distinction function 26A for distinguishing a class of the token from the host 10, a header separation function 26B for separating a header of the received token, and a comparison function 26C for comparing the header to distinguish whether the token is to the same device or not. The details of these functions 26A, 26B, and 26C are described below. For comparison of the comparison function 26C, the CPU 26 stores a header information of the OUT packet separated by the header separation function 26B, a packet ID (identification data) of the DATA 0/1 packet, and a header information of the PING packet in a memory 28. The information that is necessary for the comparison in the header information is an address and an end point of the USB device 12, each is included in an IN packet and the OUT packet from the host 10.

The wireless conversion device 30 performs a code transformation suitable for the wireless communication, for example 8B/10B transformation, to the packet from the down buffer 24, and converts the infrared light signal, and transmits to the device side repeater 40.

The device side repeater 40, basically, only converts a wireless signal from the host side repeater 20 to a USB packet format, transfers to the device 12, and only converts the USB packet from the device 12 to the wireless signal, transfers to the host side repeater 20. That is, a wireless conversion device 42 of the device side repeater 40 receives the infrared light signal from the wireless conversion device 30 of the host side repeater 20, performs the 10B/8B transformation, returns to packet structure before the conversion in the wireless conversion device 30, and supplies to a down buffer 44. The down buffer 44 directly supplies the packet from the wireless conversion device 42 to a USB transmitter/receiver 48. The USB transmitter/receiver 48 adds sink codes, etc. which are necessary for the USB packet transmission to the packet from the wireless conversion device 30, makes the USB packet structure, and supplies to the device 12 via the USB bus 16.

The CPU 46 of the device side repeater 40 controls initialization of the device side repeater 40 and link establishment of the wireless communication with the host side repeater 20.

The packet that the device 12 transmits to the host 10 inputs the USB transmitter/receiver 48 of the device side repeater 40 via the USB bus 16. The USB transmitter/receiver 48 receives the packet from the USB bus 16 and supplies to an up buffer 50. The up buffer 50 takes the packet from the USB transmitter/receiver 48, and directly outputs to the wireless conversion device 42.

The wireless conversion device 42 performs a code transformation suitable for the wireless communication, for example 8B/10B transformation, to the packet from the up buffer 50, and converts the infrared light signal, and transmits to the host side repeater 20.

The wireless conversion device 30 of the host side repeater 20 receives the infrared light signal from the device side repeater 40, performs the 10B/8B transformation, returns to packet structure before the conversion in the wireless conversion device 42, and supplies to a up buffer 32. The up buffer 32 buffers the packet from the wireless conversion device 30, and reads to the USB transmitter/receiver 22 under the control of the CPU 26. The CPU 26 always watches a class of a response from the device 12 stored in the up buffer 32.

The USB transmitter/receiver 22 adds sink codes, etc. which are necessary for the USB packet transmission to the packet from the up buffer 32, makes the USB packet structure, and supplies to the host 10 via the USB bus 14.

Also, a NAK, ACK packet generation device 34 generates the NAK packet or the ACK packet under the control of the CPU 26, and supplies to the USB transmitter/receiver 22. The USB transmitter/receiver 22 adds sink codes, etc. which are necessary for the USB packet transmission to the packet from the NAK, ACK packet generation device 34, makes the USB packet structure, and supplies to the host 10 via the USB bus 14.

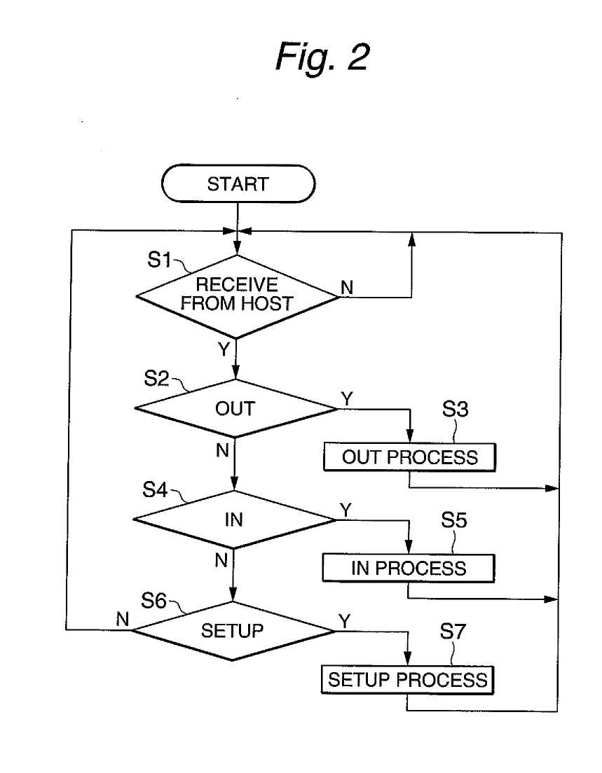

FIG. 2 shows a main flow of the CPU 26 of the host side repeater 20. As explained above, the USB packet outputted from the host 10 and inputted to the host side repeater 20 is stored in the down buffer 24 and is taken in the CPU 26 (S1). The token distinction function 26A of the CPU 26 distinguishes whether the USB packet is any of OUT, IN or SETUP (S2, S4, S6), depending on each, the CPU 26 performs relay processes (S3, S5, S7). That is, the CPU 26 performs the relay process of the OUT transaction for the OUT packet (S2, S3), the CPU 26 performs the relay process of the IN transaction for the IN packet (S4, S5), the CPU 26 performs the relay process of the SETUP transaction for the SETUP packet (S6, S7).

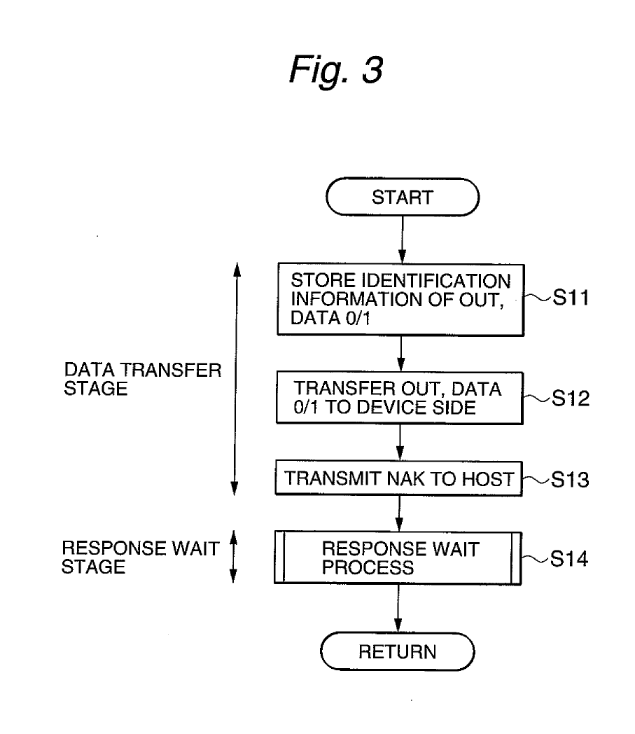

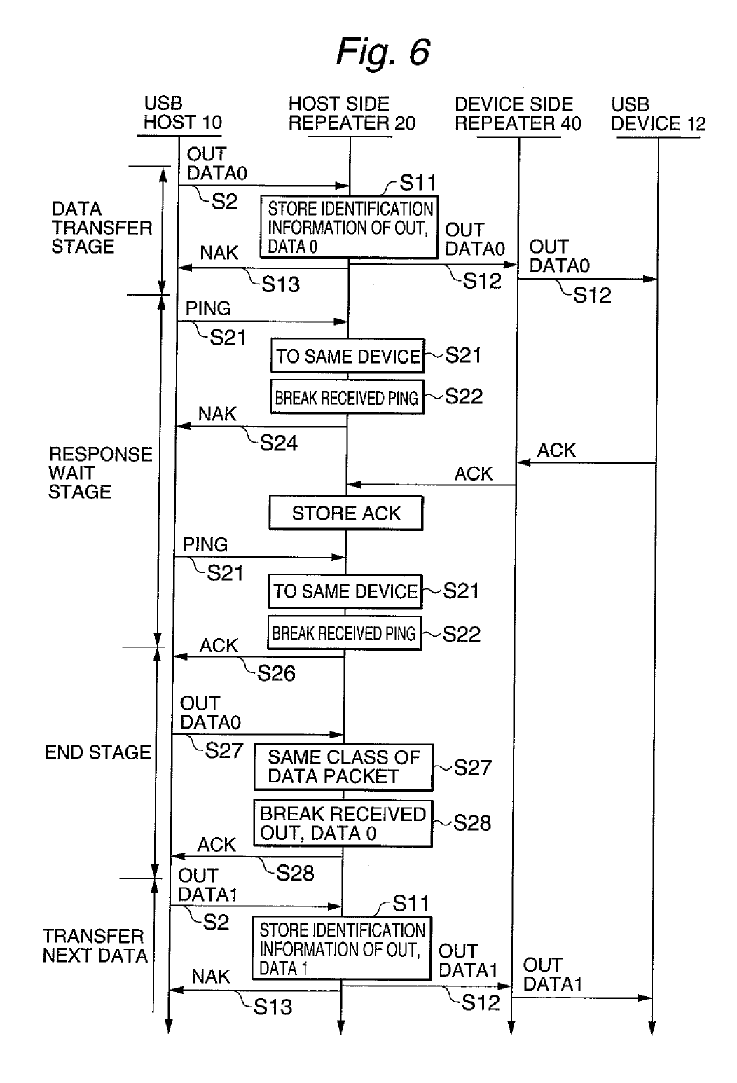

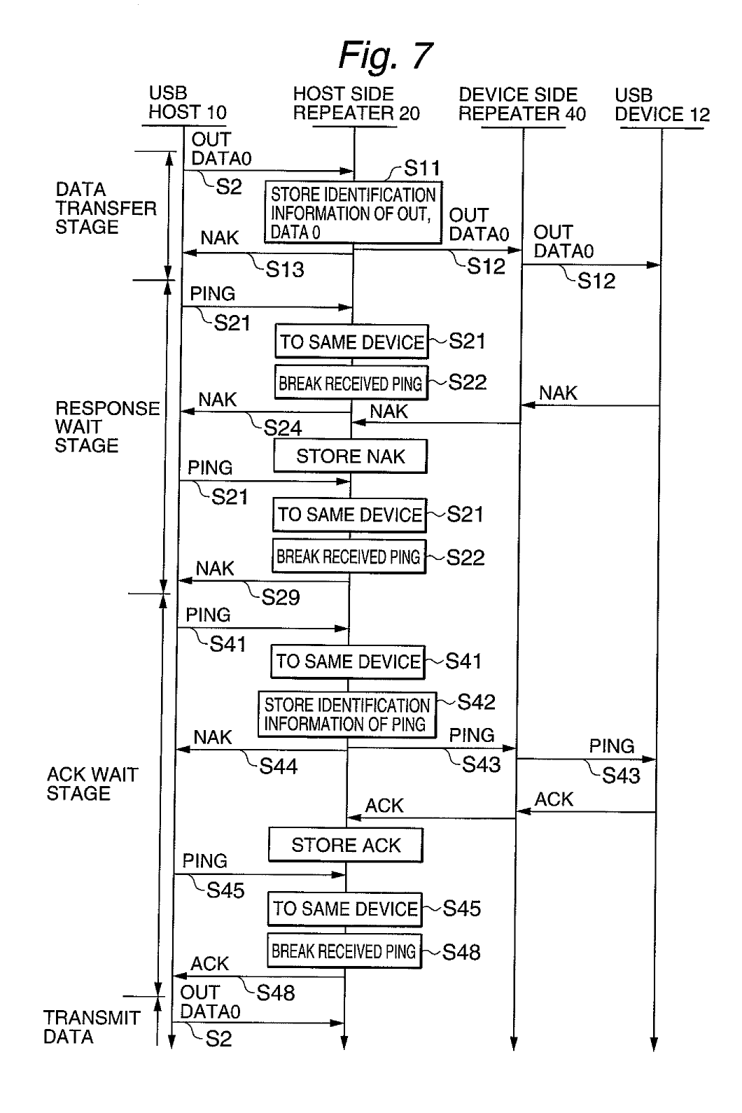

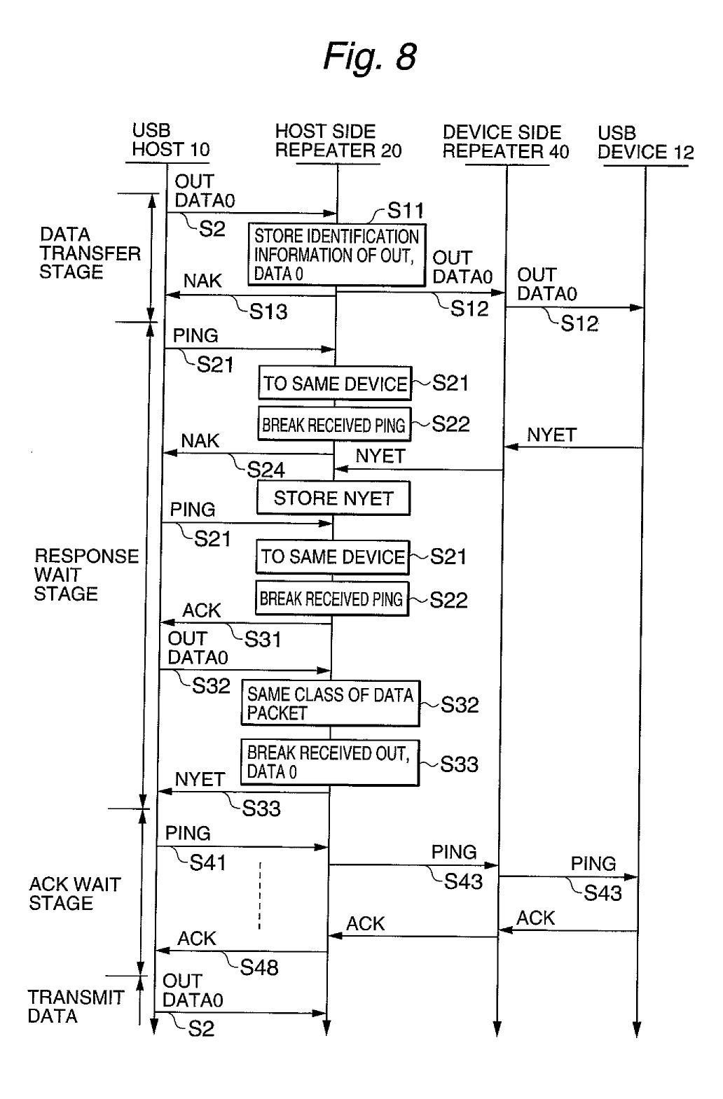

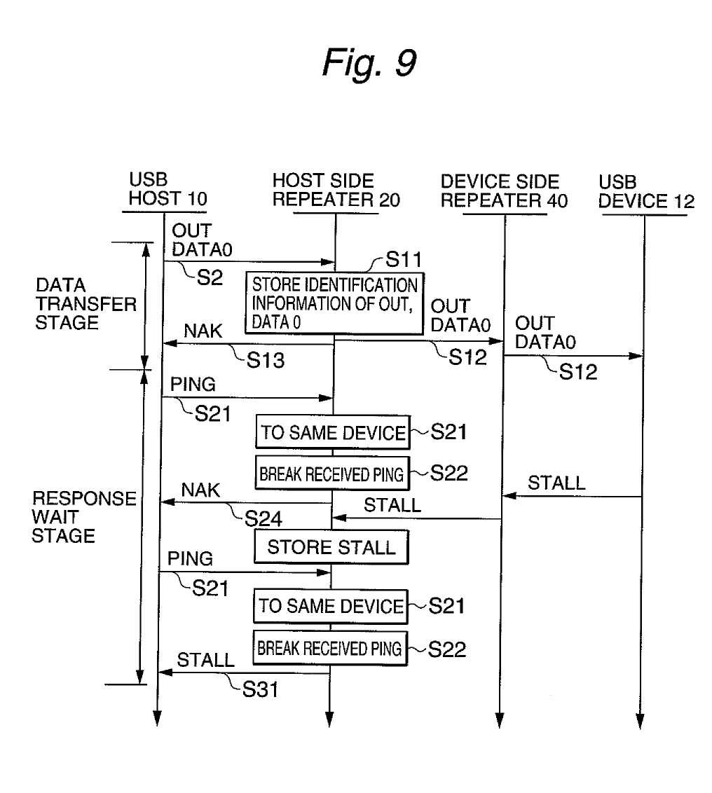

FIGS. 3 to 5 show a flow chart of the OUT transaction relay process shown in the step S3. FIG. 6 shows a sequence example of the OUT transaction in the present embodiment when the device 12 replies the ACK packet against the DATA packet. FIG. 7 shows a sequence example of the OUT transaction in the present embodiment when the device 12 replies the NAK packet against the DATA packet. FIG. 8 shows a sequence example of the OUT transaction in the present embodiment when the device 12 replies the NYET packet against the DATA packet. FIG. 9 shows a sequence example of the OUT transaction in the present embodiment when the device 12 replies the STALL packet against the DATA packet. In the FIGS. 6 to 9, the steps corresponding to the flows shown the FIGS. 3 to 5 are added.

The USB 2.0 introduced the PING packet for speed up. As long as the transmission rate of the communication media used between the repeater 20, 40 does not exceed the rate of the USB 2.0 to a large degree, the host side repeater 20 have to reply a response for the device 12, i.e. proxy response, to the host 10. In the present embodiment, the CPU 26 performs as below against the OUT packet and the PING packet outputted to the same device 12 from the host 10. In addition, whether the packet to the same device 12 or not is decided by comparing the header of the each packet, more specifically, by comparing the destination address indicating the device 12 and the part comprising the end point (EP), if these are the same, it is judged that the packets are to the same device. The class of the data packet i.e. DATA 0 or DATA 1 is decided by comparing its packet identifier data (ID).

In present embodiment, the host side repeater 20 has a data transfer stage, a response wait stage, an end stage, a data retransmission stage, a communication stop stage as the relay process of the OUT transaction. The data transfer stage is the stage to transfer the data from the host 10 to the device 12. The response wait stage is the stage to wait the response from the device. The end stage is the stage to switch to next data transfer against the ACK packet from the device. The data retransmission stage is the stage to retransmit the data against the NAK or NYET packet from the device 12. The communication stop stage is the stage to transfer the STALL packet from the device 12 to the host 10.

In the FIG. 3, first, as the data transfer stage, the header separation function 26B of CPU 26 separates the identification information of the OUT packet and the following DATA 0/1 packet from the host 10, and stores in the memory 28 (S11). This identification information comprises of at least device address and end point information in the header information of the OUT packet and the packet identifier of the DATA 0/1 packet.

The CPU 26 reads the OUT packet and the DATA 0/1 packet stored in the down buffer 24 to the wireless conversion device 30 (S12). Thereby, as explained above, the OUT packet and the DATA 0/1 packet are transferred to the device 12. At the same time or almost simultaneously, the CPU 26 transmits the NAK packet from the NAK, ACK packet generation device 34 to the host 10 (S13).

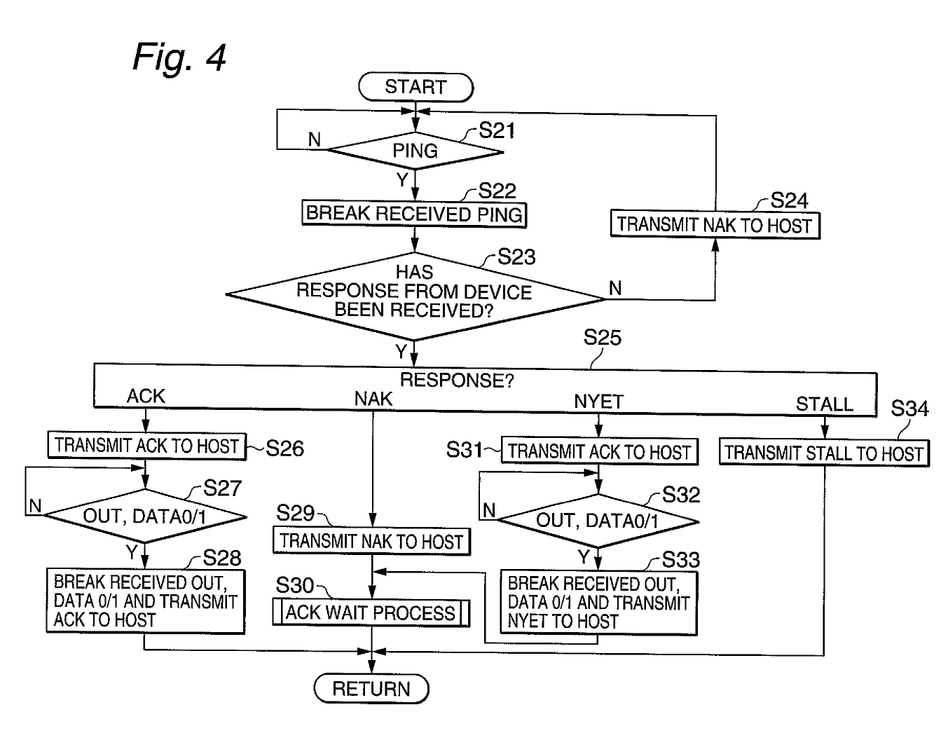

After the above data transfer (S12) and the NAK response (S13), the CPU 26 switches to the response wait process (S14). FIG. 4 shows a detailed flow chart of the response wait process (S14). The host side repeater 20 waits the PING packet from the host 10 to the same device 12 (S21). Whether the packet is the PING packet is decided by comparing the packet identifier of the token from the host 10 with the token distinction function 26A. In addition, whether the packet is to the same device is decided by comparing the device address and end point stored in the header of the token from the host 10 and the information corresponding to the header of the OUT packet recorded in the memory 28. The received PING packet, as explained above, is stored in the down buffer 24, and supplies to the CPU 26.

If the CPU 26 receives the PING to the same device 12 (S21), the CPU 26 does not transfer to the device 12, erase this PING packet from the down buffer 24 (S22), decides whether the response signal from the device 12 has been received, i.e. the response signal has been stored in the up buffer (S23). Since the PING is not always transferred, the load of the wireless transmission part and the device side repeater 40 is reduced.

If the CPU 26 does not receive the response from the device 12 (S23), the CPU 26 transmits the NAK packet from the NAK, ACK packet generation device 34 to the host 10 (S24), and waits to receive the next PING (S21). Since the PING packet is broken without transferring to the device 12, the useless receiving process of device 12 is reduced. Also, the host 10 transmits the PING packet to the same device 12 against this NAK packet in a constant time interval.

If the CPU 26 has received the response from the device 12 (S23), the flow branches whether the response is any of ACK, NAK, NYET, or STALL (S25).

If the ACK packet as the response from the device 12 is stored in the up buffer 32 (S25), this implies that data is stored in the device 12 by foregoing OUT packet and following DATA 0/1 packet. In this situation, the CPU 26 read the ACK packet of the up buffer 32 and sends back to the host 10 (S26). This ACK packet becomes a receive approval signal against the PING packet from the host 10.

The host 10, based on the USB specification, again transmits the same data with the data forward transmitted to the device 12 with the OUT packet and DATA 0/1 packet to the device 12 against the ACK packet for the PING packet. For example, if the first data packet is the DATA 0 packet, the retransmitted DATA packet is the same DATA 0 packet.

The host side repeater 20 waits the OUT packet and following DATA 0/1 packet from the host 10 to the same device 12 (S27). If the CPU 26 receives the OUT packet and following DATA 0/1 packet, the CPU 26 compares the header information of the OUT packet and the packet ID of the DATA 0/1 packet with the header information of the first OUT packet and the packet ID of the DATA 0/1 packet recorded in the memory 28 previously with the comparison function 26C. By this comparison, the CPU 26 can decide whether the data is the transmitted data to the same device or not, i.e. retransmission of the same data or not.

In particular, it can be decided whether to the same device or not by comparing the header information of the OUT packet. Also, since the host 10 has received the NAK packet against the first DATA packet, the DATA packet transmitting in this stage is the same DATA packet (if the first DATA packet is the DATA 0 packet, the first DATA packet transmitting in this stage is also the DATA 0 packet). By comparing the packet identifier of the DATA packet, it can be decided whether the same class or not.

After checking that the data is the data transferred to the device 12 in the transfer stage, the CPU 26 deletes the received OUT packet and the following DATA 0/1 packet from the down buffer 24 without transferring to the device 12, and transmits the ACK packet to the host 10 (S28). The CPU 26 erases the record of the header information of the first OUT packet and the packet ID of the DATA 0/1 packet from the memory 28.

At the step 28, the OUT transaction terminated normally, the host 10 can start the OUT transaction to transmit the next data.

If the response from the device 12 is the NAK packet (S25), this implies that the device 12 did not receive the data with foregoing OUT packet and following DATA 0/1 packet, the host side repeater 20 has to wait until the device 12 becomes the state that the device 12 can receive the data. For this reason, the CPU 26 reads the NACK packet of the up buffer 32 and sends back to the host 10 (S29). Needless to say, the CPU 26 may break the NAK packet of the up buffer 32 and has the NAK, ACK packet generation device 34 generate the NAK packet.

The NAK packet transmitted to the host 10 in the step S29, for the host 10, is the response signal of receiving failure against the PING packet from the host 10, the host 10 repeatedly transmits the PING packet until the device 12 sends back the ACK packet. Corresponding to this, the CPU 26 enters the ACK response wait process from the device 12.

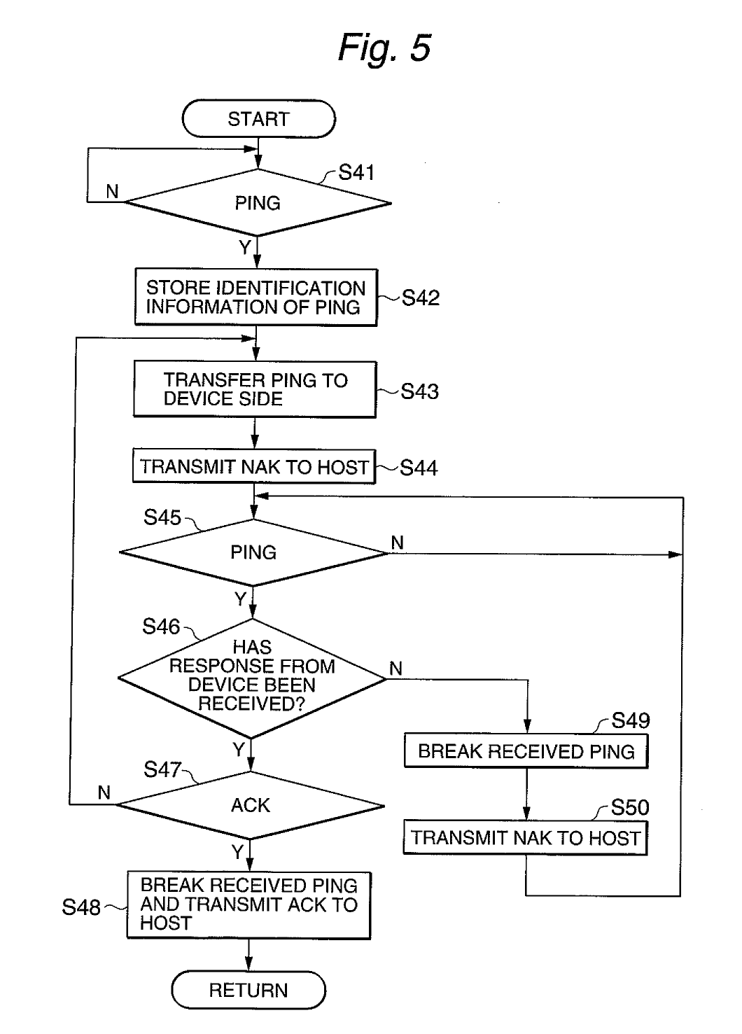

FIG. 5 shows a detailed flow chart of the ACK response wait process (S30). The host side repeater 20 waits the receiving the PING packet to the device 12 from the host 10 (S41). The CPU 26 stores the identification information (in particular, device address and end point) of the received PING packet in the memory 28 (S42). Since the NAK packet is received from the device 12 against the OUT packet and the DATA 0/1 packet, it is necessary to reset the OUT transaction. For this reason, the header information and PID recorded against the OUT packet and the DATA 0/1 packet is erased from the memory 28.

The CPU 26 also reads the received PING packet from the down buffer 24 and transmits to the device 12 (S43), and transmits the NAK packet to the host 10 (S44).

Afterward, the CPU 26 waits to receive the PING packet from the host 10 to the same device 12 (S45). Whether the same device 12 or not is decided by comparing the identification information of the received PING packet with the identification information recorded in the memory 28 at the step S42. If the PING packet to the same device 12 is received (S45), the CPU 26 checks whether the response from the device 12 is received (S46).

It the response is received (S46), the CPU 26 checks whether the response is the ACK packet or not (S47). Only if the ACK packet is received from the device 12 (S47), the CPU 26 breaks the PING packet stored in the down buffer 24, and read the ACK packet stored in the up buffer 32, and transmits to the host 10 (S48), and terminated the flow shown in the FIG. 5. Needless to say, the CPU 26 may break the ACK packet of the up buffer 32 and has the NAK, ACK packet generation device 34 generate the ACK packet, and has the USB transmitter/receiver 22 transmit.

If the response is not the ACK (S47), the CPU 26 reads the PING packet received previously and stored in the down buffer 24, and transmits to the device 12 (S43), and transmits the NAK packet to the host 10 (S44). Thereby, the host 10 waits until the device 12 responses to the ACK packet.

If the CPU 26 does not receive the response from the device 12 (S46), the CPU 26 breaks the PING packet stored in the down buffer 24 (S49), and transmits the NAK packet to the host 10 (S50). That is, the CPU 26 has the NAK, ACK packet generation device 34 generate the NAK packet, and transmits to the host 10 via the USB transmitter/receiver 22. Afterward, the CPU 26 returns the step S45 and waits for the next PING packet.

In this embodiment, providing the step S49, it prevents a plurality of the PING packet from transmitting before the response from the device 12. This prevents the device 12 from making busy, and prevents waste of band frequency of the wireless transmission path between the repeater 20 and 40.

The ACK packet transmitted to the host 10 in the step S48 is, for the host 10, the response against the PING packet. This implies that the device 12 is the state that the device 12 can receive the data. The host 10 starts again the OUT transaction which carries the same data with the data transmitted in the step S11 against this ACK packet. In this sense, the ACK wait process shown in the FIG. 5 is the process to prompt the data retransmission to the host 10.

If the NYET packet as the response from the device 12 is stored in the up buffer 32 (S25), this implies that device 12 is not ready to receive the data with foregoing OUT packet and following DATA 0/1 packet, it is necessary to transmit the NYET packet to the host 10. FIG. 8 shows a sequence example of this case.

According to the USB protocol, since the device can response the NYET packet only against the OUT packet and the DATA 0/1 packet, the CPU 26 has the NAK, ACK packet generation device 34 generate the ACK packet, and has the host 10 transmits it via USB transmitter/receiver 22 (S31).

The host 10, based on the USB specification, again transmits the same data with the data forward transmitted to the device 12 with the OUT packet and DATA 0/1 packet to the device 12 against the ACK packet for the PING packet. For example, if the first data packet is the DATA 0 packet, the retransmitted DATA packet is the same DATA 0 packet.

The host side repeater 20 waits the OUT packet and following DATA 0/1 packet from the host 10 to the same device 12 (S32). If the CPU 26 receives the OUT packet and following DATA 0/1 packet, the CPU 26 compares the header information of the OUT packet and the packet ID of the DATA 0/1 packet with the header information of the first OUT packet and the packet ID of the DATA 0/1 packet recorded in the memory 28 previously with the comparison function 26C. By this comparison, the CPU 26 can decide whether the data is the transmitted data to the same device or not, i.e. retransmitting of the same data or not.

In particular, it can be decided whether to the same device or not by comparing the header information of the OUT packet. Also, since the host 10 has received the NAK packet against the first DATA packet, the DATA packet transmitted in this stage is the same class of the DATA packet (if the first DATA packet is the DATA 0 packet, the first DATA packet transmitted in this stage is also the DATA 0 packet). By comparing the packet identifier of the DATA packet, it can be decided whether the same class or not.

Since the device 12 is not in condition to be able to receive data, the CPU 26 erases the OUT packet and the DATA 0/1 packet retransmitted from the host 10 from the down buffer 24, reads the NYET packet from the up buffer 32 and transmits to the host 10 (S33).

Afterward, in order to check that the device 12 become the condition to be able to receive data, the host 10 transmits the PING packet to the device 12 repeatedly or periodically. Also, the host side repeater 20 executes the ACK wait process (S30), and waits that the devices 12 becomes the condition to be able to receive data. Since the sequence in the ACK wait process is the same as the FIG. 7, in FIG. 8, the detail of the ACK wait process is omitted.

If the STALL packet as the response from the device 12 is stored in the up buffer 32 (S25), this implies that the communication function of the device 12 and the communication path between with the device 12 has a failure. In this situation, the CPU 26 reads the STALL packet of the up buffer 32 and transmits to the host 10 (S34). Ordinarily, against the STALL packet, the host 10 quits the communication with device 12 afterward. FIG. 9 shows a sequence example of this case.

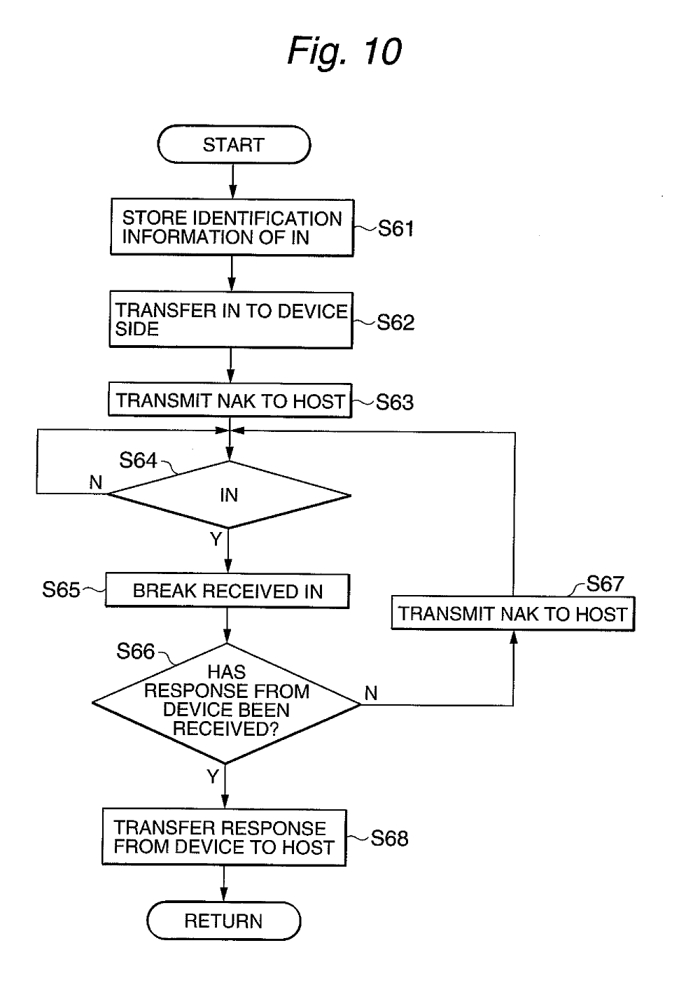

FIG. 10 shows a flow chart of an IN transaction process (S5). The header separation function 26B of the CPU 26 separates the identification information of the In packet from the host 10, and stores in the memory 28 (S61). This identification information comprises of at least the device address and the information of the end point of the header information of the IN packet.

The CPU 26 reads the IN packet stored in the down buffer 24 to the wireless conversion device 30 (S62). Thereby, as explained above, the IN packet is transferred to the device 12. At the same time or almost simultaneously, the CPU 26 transmits the NAK packet from the NAK, ACK packet generation device 34 to the host 10 (S63).

Afterward, the host side repeater 20 waits the IN packet from the host 10 to the same device 12 (S64). Whether the IN packet or not is decided by comparing the packet identifier of the token from the host 10 with the token distinction function 26A. In addition, whether the packet to the same device or not is decided by comparing the device address and end point stored in the header of the token from the host 10 and information corresponding to the header of the IN packet recorded in the memory 28 with the comparison function 26C. The received IN packet, as explained above, is stored in the down buffer 24, and supplies to the CPU 26.

If the CPU 26 receives the IN packet to the same device 12, the CPU 26 does not transfer to the device 12, erases this IN packet from the down buffer 24 (S65), and decides whether the response signal from the device 12 has been received (S66). The response from the device 12 is any of the DATA 0/1 packet, the NAK packet or the STALL packet.

If the CPU 26 does not receive the response from the device 12 (S66), the CPU 26 transmits the NAK packet from the NAK, ACK packet generation device 34 to the host 10 (S67), and waits to receive the next IN packet (S64). Since the IN packet is broken without transferring to the device 12, the useless receiving process of the device 12 is reduced. Also, the host 10 transmits the IN packet to the same device 12 against the NAK packet of the step S67.

If the CPU 26 has received the response from the device 12 (S23), the CPU 26 reads the response from the device 12 from the up buffer 32, transmits to the host 10 (S68) and returns the step S1 in FIG. 2.

In the SETUP process (S7) of the FIG. 2, the host side repeater 20 transmits the SETUP packet and following DATA 0/1 packet from the host 10 to the device 12, and transmits the ACK packet to the host 10. Because, the response against the SETUP packet is limited to the ACK packet. The SETUP packet and DATA 0/1 packet from the host side repeater 20 are inputted in the device 12 via the device side repeater 40. The device 12 sends back the ACK packet as the response. The device side repeater 40 transfers the ACK packet from the device 12 to the host side repeater 20. The host side repeater 20 breaks the ACK packet from the device 12 inputted via the device side repeater 40. Because this has been transmitted to the host 10.

Although the embodiment for the USB was explained, the present invention is generally applicable to the transmission system that the host controls the transmission of the device and limits the transmission of the device for a predetermined period after the device received a signal from the host.

Although the present invent was explained the particular embodiment for explanation, many widely different alternations and modifications of the present invention may be constructed without departing from the spirit and scope of the present invention defined claims for those skilled in the art, these alternations and modifications are within scope of the present invention.

1. A repeater relaying communication in a communication system that a host controls a transmission of a device and limits the transmission of the device for a predetermined period after the device received a signal from the host, the repeater comprising:
a down buffer for temporarily storing a down signal from said host to said device;
a up buffer for temporarily storing a up signal from said device to said host;
a response packet generation means for generating a predetermined response packet that should be transmitted to said host; and
a control means for controlling said down buffer, said up buffer and said response packet generation means according to said up signal and said down signal, wherein the control means
(1) transfers an inquiry signal from said host to the device to said device via said down buffer, has a NAK signal generate with said response packet generation means, and transmits to said host,
(2) has the NAK signal generate with said response packet generation means and transmits to said host against the inquiry signal from said host before receiving the response from said device,
(3) transmits an ACK signal to said host if the response from said device is the ACK signal, and transfers said inquiry signal to said device via said down buffer, has the NAK signal generate with said response packet generation means, and transmits to said host if the response from said device is not the ACK signal against the inquiry signal from said host immediately after having received the response from said device.

2. A method relaying an inquiry signal from a host to device in a communication system that the host controls a transmission of the device and limits the transmission of the device for a predetermined period after the device received a signal from the host, the method comprising steps of:
transferring the inquiry signal from said host to said device, and transmitting a NAK signal to said host,
transmitting the NAK signal to said host against the inquiry signal from said host before receiving the response from said device, and
transmitting an ACK signal to said host if the response from said device is the ACK signal, and transferring said inquiry signal to said device and transmitting the NAK signal to said host if the response from said device is not the ACK signal against the inquiry signal from said host immediately after having received the response from said device.
